(19) United States
(12) Patent Application Publication
(10) Pub. No.: US 2007/0277083 A1
(43) Pub. Date: Nov. 29, 2007

(54) Data Handling Device That Corects Errors In A Data Memory

(75) Inventors: Victor Martinus Gerardus Van Acht, Eindhoven (NL); Albert W. Marsman, Eindhoven (NL); Boon Keat Chong, Kuala Lumpur (MY); Nicolaas Lambert, Eindhoven (NL); Pierre Hermanus Woerlee, Eindhoven (NL); Teunis Jan Ikkink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,825

(22) PCT Filed: Apr. 4, 2005
(86) PCT No.: PCT/IB05/51106

§ 371 Date: Oct. 11, 2006

(30) Foreign Application Priority Data
Apr. 14, 2004 (EP) 04101519.9

(51) Int. Cl. G06F 11/10

(52) U.S. Cl. 714/807

(57) ABSTRACT

A data handling device is provided with a data memory (10) with an address input and a data output, for outputting multi-bit words. The data memory (10) has a structure that gives rise to potential errors at correlated positions in words from a group of words. An erasure memory unit (16) stores bit position information associated with a group of the words, and outputs the bit position information when a word from the group for which bit position information is stored is addressed in the data memory (10). An error correction and detection unit (12) is arranged to correct words from the data memory (10), using error erasure for bits at bit positions selected by the bit position information from the erasure memory unit (16) for the groups to which the words belong.

The invention relates to a data-handling device that comprises a data memory and an error correction unit to correct errors in data words that have been read from the data memory.

U.S. Pat. No. 4,335,458 discloses a circuit with a memory and an error correction circuit that uses an Error Correcting Code (ECC) for correcting errors in data words that have been read from a memory. As is well known, when an ECC is used, data is stored encoded in words that belong to a set of ECC words, which contain more bits than the encoded data words, so that different ECC words always mutually differ at a plurality of bit positions. During error correction of a data word from memory that ECC word is selected that normally differs at the least number of bit positions from the word has been read.

The aforementioned U.S. Pat. No. 4,335,458 observes that the ratio between the number of bits in the data words and the number of bits in the ECC words can be reduced by using larger data words, but that for other reasons data words should not be too large. The document applies this observation to a scheme wherein ECC code words are made up of four separately addressable data words. When a particular data word is addressed, initially only a part of the larger ECC code word that contains the addressed data word is read and used to detect whether there is an error. If an error is detected the other three parts of the ECC code word, which contain the other three data words, are read from other addresses and the entire ECC code word is used during error correction.

The aforementioned U.S. Pat. No. 4,335,458 uses separate memories for bits at different positions in the data words. This gives rise to the risk that the bits at the same position may be in error in a plurality of words. The document notes that this type of error can be corrected effectively by treating the ECC code words as made up of symbols, each symbol containing bits from the same position in different data words, and by using an error correction technique that corrects symbols as a whole. Because combined errors due to malfunctioning memories occur concentrated in symbols, a higher number of bits can be corrected in one symbol than if the bits where arbitrarily distributed throughout ECC code word. As a result the ratio between the number of bits in the data words and the number of bits in the ECC words can be kept small.

However, the scheme proposed by the aforementioned U.S. Pat. No. 4,335,458 has the disadvantage that a plurality of words has to be read each time when an error occurs. This means that errors cause variable delays, unless one always uses a delay sufficient to read all data words if there is no error. Alternatively, variable delays can be avoided by each time reading all words from an ECC word in parallel. However, this needlessly reduces memory speed and/or needlessly increases the amount of access circuitry if only one of the data words is needed.

Among others, it is an object of the invention to correct errors in data words from memories, making use of correlations between errors at related bit positions in different data words, while reducing the overhead for reading multiple data words to correct errors.

Among others, it is an object of the invention to correct errors in data words without needing a large correction memory.

A device according to the invention is set forth in claim 1. According to the invention an erasure memory unit is used to keep a record of bit positions at which errors have been detected in data words from respective groups of data words, the erasure memory containing bit position information for at least one group at a time. This record is used when another word from a group is read, by “erasing” bits for the purpose of error correction, from positions that are related to a bit position or positions for which an error or errors have been recorded. “Erasing” is used herein in the special sense used in the art of error correcting codes. As used herein Erasing comes down to ignoring a bit from an erased position or bits from erased positions when selecting the ECC code word that differs at the least number of positions from the word read from memory. The invention is intended for memories that suffer from memory failures that affect bits in predetermined groups, so that all bits of the group are affected by the failure together.

In one example, the memory is a NAND Flash memory, in which each group corresponds to a plurality of storage transistors whose main current channels are connected in series, so that a bit must be read from a transistor in a group by making the other transistors in the group conductive. In this case a memory failure that affects the series connection of the main current channels may cause errors to all bits that are stored in the storage transistors in the group.

The erasure memory unit may have respective locations for erase bit positions for all groups in the data memory. However, according to a further aspect of the invention, the erasure memory unit memory may have fewer locations than the number of groups in the data memory. Thus, a smaller erasure memory unit suffices. In this case an associative memory is preferably used, which stores bit position information and associated group addresses. The content of the associative memory is update during use. When an address is used to address the data memory, the bit information stored in association with the address of the group is retrieved. A storage location in the erasure memory unit is preferably reused for a particular group, replacing information for another group, when an error is detected when a word from the particular group is read from the data memory and no bit position information is currently stored for the particular group. Thus, only a small number of storage locations for erasure information is needed. In a simple embodiment only one storage location is provided for all groups in the data memory.

According to another aspect of the invention the erasure memory unit validates bit position information for a group for use in erasure only after errors have been detected at the same bit position or positions in a plurality of words from a group. Thus, the risk of erasure due to random errors is reduced.

According to a further aspect of the invention the device is arranged to respond to detection of an uncorrectable error in a word from a particular group by addressing other words in the particular group. If the uncorrectability was caused by random errors this makes it possible to find erasure bit positions, which may make it possible to correct the originally uncorrectable word.

Preferably, the erasure memory is configurable so that it can handle different structures of groups of words.

These and other objects and advantageous aspects of the invention will be illustrated using examples of embodiments that are shown in the following figures.

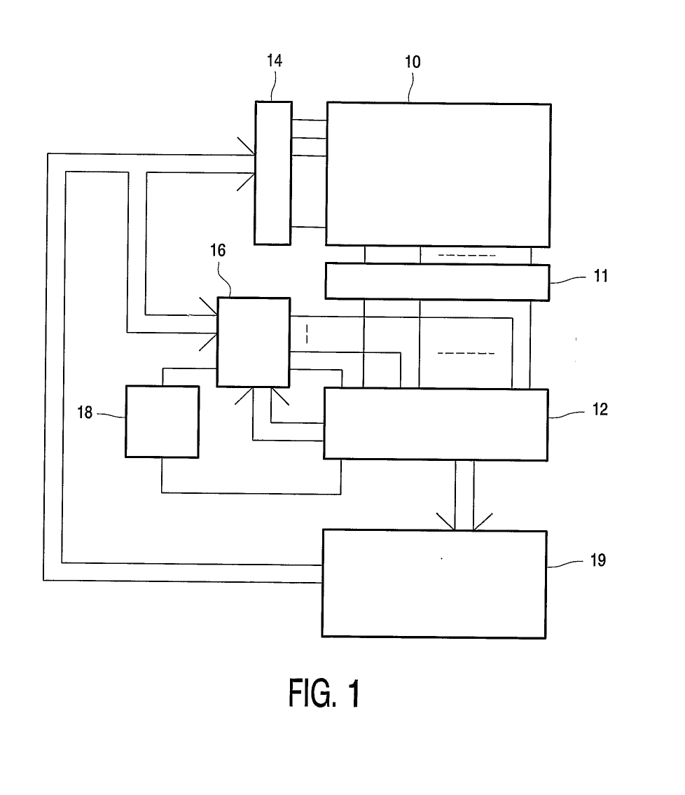

FIG. 1 shows a circuit with a memory matrix;

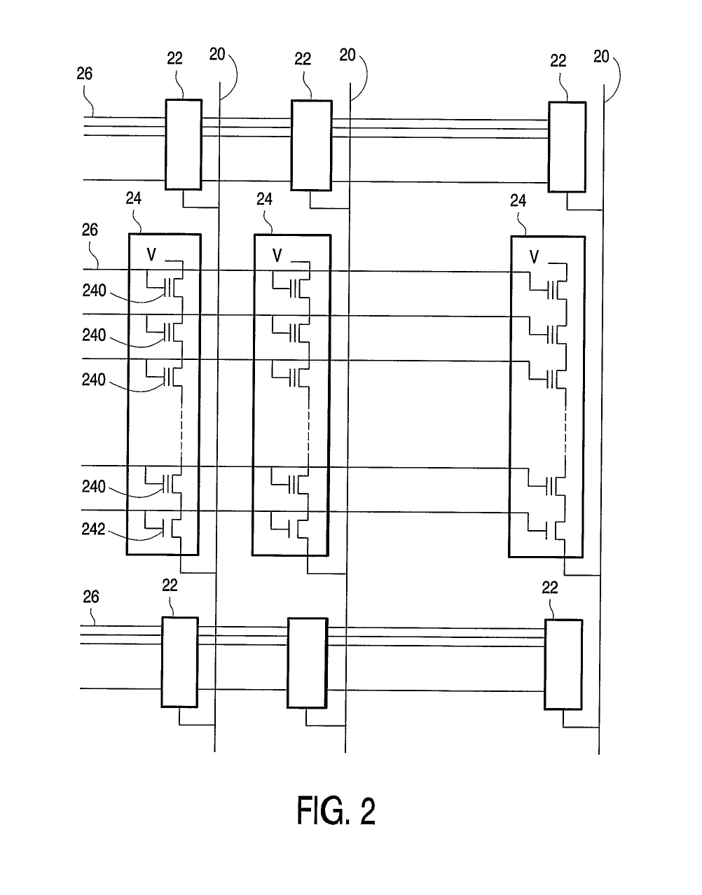

FIG. 2 shows a detail of a memory matrix;

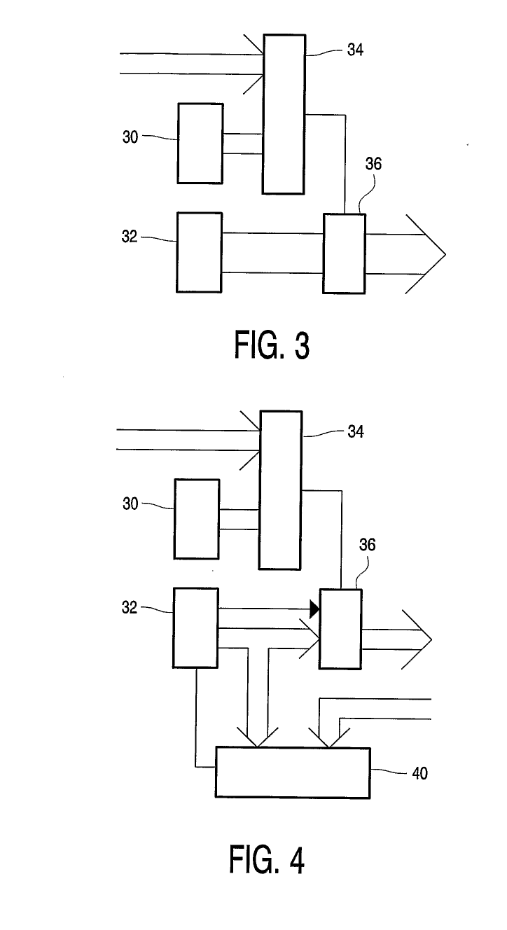

FIG. 3 shows an example of an erasure memory unit;

FIG. 4 shows another example of an erasure memory unit.

FIG. 1 shows a device with a memory matrix 10, a sense circuit 11, an error correction and detection circuit 12, an addressing circuit 14, an erasure memory circuit 16, an update circuit 18 and processing circuitry 19. Processing circuitry 19 has an address output coupled to address inputs of addressing circuit 14 and erasure memory circuit 16. Addressing circuit 14 has outputs coupled to memory matrix 10, which has bit lines coupled to sense circuit 11. Both sense circuit 11 and erasure memory circuit 16 have outputs coupled to error correction and detection circuit 12. Error correction and detection circuit 12 has a corrected data output coupled to processing circuitry 19, an error location signalling output coupled to erasure memory circuit 16 and an error detection output coupled to update circuit 18. Update circuit 18 has a control output coupled to erasure memory circuit 16.

Memory matrix 10 is of a type for which it is known that certain errors are likely to occur jointly at related positions in predetermined groups of words. One example of this type of memory is a NAND flash memory.

FIG. 2 shows an example of a NAND flash memory matrix. The matrix contains memory transistors 240 with floating gates, i.e. gate electrodes that retain a charge that represents data. The memory is organized in rows and columns of memory transistors. Each column corresponds to a bit line 20 and is organized in groups 22, 24 of memory transistors 240 (memory transistors from only one group 24 being shown explicitly). The main current channels of the memory transistors 240 are connected in series between a power supply connection V (typically ground) and the bit line 20 of the column. Selection lines 26 from addressing circuit 14 (not shown) are each connected to gate electrodes of memory transistors 240 in a respective row of the matrix.

In operation, when a group of rows and a specific row within a group is addressed, addressing circuit 14 applies row voltages to make the memory transistors 240 unconditionally conductive (unconditionally in the sense of independent of the data) to all but the addressed row in the addressed group. Addressing circuit 14 makes group access transistors 242 of not-addressed rows non-conductive and/or makes at least one memory transistor of each not-addressed rows unconditionally non-conductive. To the selection line 26 of the addressed row addressing circuit 14 applies a voltage that makes the conductivity of the main current channels of the memory transistors 242 in that row depend on the data stored in the memory transistor 240 (the charged stored on its floating gate).

It will be appreciated that in case of any failure that makes the series connection of main current channels in a group 22, 24 non-conductive errors will arise irrespective of the addressed row in a group. In one embodiment, the memory produces data words that each contain information from an entire row, so that groups of rows correspond to groups of words with correlated errors. In another embodiment all rows are subdivided into parts, each part corresponding to a respective words. In this embodiment a group of rows corresponds to a plurality of groups of words, so that an error in one column leads to correlated errors in one of these groups of words, but not in the other groups of words.

The operation of the circuit of FIG. 1 is as follows. Processing circuit 19 issues addresses to addressing circuit 14. Addressing circuit uses these addresses to select cells in memory matrix 10. Dependent on the data stored in the addressed cells different bit line signals are produced at the inputs of sense circuit 11. Sense circuits 11 generate digital signals as a function of the bit line signals. Error correction and detection circuit 12 uses the digital signals to decode a data word, correcting errors if necessary, and applied the decoded word to processing circuitry 19.

The data word that is applied to error correction and detection circuit 12 may contain digital signals derived from all of the bit lines in memory matrix 10, so that a whole row of the matrix contributes in response to an address. In another embodiment, however, the address selects one of a number of parts into which a row is subdivided. In this embodiment only signals from the bit lines of the selected part are used to obtain the digital signal for error correction and detection circuit 12 (in this case part of the address may be applied to sense circuit 11 to select signals from the addressed part).

During decoding and error correction, error correction and detection circuit 12 uses erasure information from erasure memory circuit 16. The erasure information indicates whether digital signals from the bit line should be ignored during error correction, and if so from which of the bit lines. Erasure decoding is known per se. It makes use of an ECC which contains codewords of n bits, selected so that each pair of codewords differs at at least d bit positions (d>3). When d=2t+1 at least t bit errors can be corrected. Erasure makes use of the fact that a derived ECC with m-1 bit codewords (or more generally m-e bit codewords) obtained by removing one or more bits from each codeword of the original ECC still ensures a minimum number of d-1 (or more generally d-e) bit positions at which codewords mutually differ. When d-e>2 then the number t′ of additional errors (additional to errors in the erased bits) that can still be corrected from the m-e bits is larger than the number t-e of errors that can be corrected from the m bit words in addition to the e erased bits.

Erasure memory circuit 16 stores erasure information that identifies respective bit positions in at least one group of separately addressable words. When an address from processing circuitry 19 addresses a word from a group, and erasure memory circuit 16 contains erasure information for that group, erasure memory circuit 16 signals error correction and detection circuit 12 to erase the bit at the bit position that is associated with the group. Typically, the addresses that are applied to addressing circuit 14 contain a first part that addresses a group and a second part that addresses words within the groups. In this case, the first part of the addresses is applied to erasure memory circuit 16, to detect whether erasure information is available for the group of addresses that share the same first part of the address.

The erasure information may take the form of a mask, with as many bits as contained in the word, or one or more addresses of a bit position or bit positions that should be erased. In response to the first part of the address erasure memory circuit 16 outputs the information for use during correction of the word that is addressed by the combination of the first and second part. In the case of a NAND flash the erasure bit position information in erasure memory circuit 16 identifies the column (bit position) and the group within the column where such an error has been detected. However, it should be understood that this is only one embodiment of the invention. In other embodiments different types of memory may be used, wherein different circuit structures give rise to errors that occur in groups of words at the same position.

Erasure memory circuit 12 may be arranged to store erasure information for one or more groups. In a first embodiment, erasure memory circuit is arranged to store erasure information for only one selectable group from a predetermined collection of groups (for example from all groups in the same memory matrix 10). In a second embodiment, a cache like memory is used to store erasure information for a plurality of selectable groups from a predetermined collection. In a third embodiment erasure information is stored for a plurality of predetermined groups.

In the first embodiment erasure memory circuit stores an address or address part and information about bit positions. The address or address part identifies the group to which the information about bit positions applies.

FIG. 3 illustrates an example of an erasure memory circuit according to this embodiment. The embodiment contains an address register 30, an erasure information register 32, an address comparator 34 and an erasure enable circuit 36. Address comparator 34 has a first input coupled to the address input of addressing circuit 14 and a second input coupled to address register 30. Address comparator 34 has an output coupled to a control input of erasure enable circuit 36. Erasure enable circuit 36 has an input coupled to erasure information register 32 and an output coupled to error correction and detection circuit 12 (not shown).

In operation, when processing circuitry 19 addresses a word in memory matrix 10 address comparator 36 compares an address part that identifies the addressed group with stored address information from address register. When there is a match, address comparator enables erasure enable circuit 36 to pass bit position information to error correction and detection circuit 12, for use in error correction. It should be emphasized that the circuit of FIG. 3 merely serves as an example. Many variations are possible, such as directly enabling or disabling error correction and detection circuit 12 to use bit position information of erasures, dependent on an address match, or enabling erasure information register 32 dependent on an address match. Erasure information register 32 which typically stores erasure bits for all positions in a word, but alternatively one or more position codes may be stored, which may be translated into erasure bits, or applied directly to error correction and detection circuit 12.

Once a word from a new group is addressed (and optionally only if an error is detected in that word) the address in address register 30 and the bit position information in erasure information register 32 is replaced by the address part of that new group and the detected bit position information.

This embodiment has the advantage of requiring little circuit overhead. The embodiment works well if processing circuitry 19 exhibits addressing locality, that is, if it addresses words in memory matrix 10 so that a plurality of addresses in one group is used before processing circuitry 19 addresses words in a next group.

In a second embodiment erasure memory circuit 16 is arranged as a cache memory, with cache memory locations that store address information and bit position information. When processing circuitry 19 applies an address the cache memory tests whether one of its locations contains address information that matched the address and, if so, returns the associated bit position information. When erasure bit position becomes available for a new group, a cache location in erasure memory circuit 12 is selected for that erasure bit position information, discarding previous information if the selected location was in use for another group. Update circuit 18 may be arranged as a cache management unit, for selecting the locations. Any cache management criterion, such as least recently used, may be used to select cache locations for this purpose. Any type of cache architecture may be used. Part of the cache that contain often used data may be locked against replacement. (For example in the file system of a USB-stick).

This embodiment requires more circuit overhead. It has the advantage that errors can be corrected more easily also if processing circuitry 19 addresses words in memory matrix in a more random sequence, mixing addresses from different groups.

In a further embodiment erasure memory circuit 16 contains locations for all groups in memory matrix 10. In this embodiment the address parts that identify the group of an addressed word is used as address to retrieve erasure bit position information for application to error correction and detection circuit 12. In another embodiment bit position information for each group may be stored in a main memory (for example in memory matrix 10 itself) and erasure memory circuit 16 may be arranged first to copy the bit position information from the main memory for a particular group, when a word from the particular group is addressed and erasure memory circuit does not yet store erasure information with a copy of the bit position information for the particular group. Retrieving erasure position information from memory matrix 10 does not need to take place first. It can happen simultaneously with retrieving the rest of the data. Also this bit position information does not need to be copied or cached in register 32 but can be send to the ECC directly and always.

Updates of erasure information are triggered when processing circuitry 19 addresses new groups and/or when error correction and detection circuit 12 detects errors. Various methods of updating are possible. In one example, wherein erasure memory circuit 12 does not store erase information for all groups at the same time (e.g. in the case of the embodiment of FIG. 3, or when a cache memory is used), erasure memory circuit signals to update circuit when processing circuitry 19 has used a particular address in a group for which there is no erasure information. If error correction and detection circuit 12 detects an error at a bit position in the particular addressed word, it signals this to update circuit 18 and supplies information that identifies the bit position of the error to erasure memory circuit 16. In response update circuit 12 causes erasure memory circuit 16 to store the bit position information and the address part that identifies the group of the particular word that was addressed, for use during correction of later addressed words from the same group.

In a further embodiment erasure memory circuit 12 is arranged to use validation information for erasure information. The validation information indicates whether erasure information for a group should be used or not for error correction. The validation information may take the form of a validation bit stored in a bit position of erasure information register 32, which is used to enable or disable output of the bit position information by enable circuit 36. As another example, the validation may be a bit that is stored with the bit position information in a cache memory. In another example the validation information takes the form of respective bits for respective bit positions, which may be stored in similar ways.

According to one aspect of the invention the validation information is set to enable use erasure information for a bit position in a particular group only once errors have been detected for that bit position in the particular group for a predetermined number of times, e.g. twice or a larger number of times. This has the advantage that it reduces the risk that a bit position will not be used for decoding words from a group due to a random bit error that occurs only in one word of the group. Erasing such a bit position would reduce the error correcting the capacity of the ECC.

This may be realized for example if update circuit 18 causes erasure memory circuit 16 first, when erasure information is newly stored in erasure memory circuit 16, to set the validation information to disable erasure. Next, update circuit 18 causes erasure memory circuit to set the validation information to enable erasure, when (a) erasure memory circuit 16 detects an address match between the group part of a subsequent address used by processing circuitry 19 and the group address stored in erasure memory circuit 16, and (b) the resulting word contains errors on the same bit positions as recorded in the stored erasure information.

FIG. 4 shows an example of an erasure memory circuit that supports this type of operation. Erasure information register 32 has a validation output coupled to enable circuit 36. Furthermore a bit position comparator 40 has been added to detect whether the bit position or positions of errors detected by error correction and detection circuit 12 match bit positions stored in erasure information register 32. Bit position comparator 40 is coupled to erasure information register 32 to set one or more validation bits in case of a match.

In operation, update circuit 18 (not shown) causes erasure memory circuit 12 to store a new address and corresponding bit position information when processing circuitry 19 addresses a word from a group whose address is not stored in address register 30. When processing circuitry 19 addresses a word from a group whose address is stored, update circuit causes bit position information register 32 to update validation information. Several implementations are possible. A first implementation uses one validation bit in erasure information register 32 for all bit positions, the validation bit being set to enable erasure if bit position comparator 40 detects that all bit positions of errors match. In a second implementation one validation bit is used for all bit positions, but the validation bit is set automatically when the group is addressed for a second time, and erasure information is cleared from erasure information register 32 for those bit positions that are not found to contain errors both times when words from the same group are decoded. In a third implementation validation bits are used for all bit positions and set for those bit positions for which errors are detected repeatedly.

It will be appreciated that similar validation techniques may be used when erasure memory circuit 16 contains a cache memory for more than one group, or memory locations for all groups. It will also be appreciated that more advanced validation conditions may be used, such as for example testing for more than two times that errors occur at the same bit position before validating erasure of that bit position. As another example, erasure memory circuit may be arranged to detect whether different words from the same group are addressed and to update the validation information only after the same bit position has been found in error in two or more different words from the same group. This ensures that a permanent random error in a word dose not lead to unnecessary erasure, but is not always needed. For example it is not needed if it is guaranteed that the same word will not be addressed repeatedly, or if the problem is only with temporary errors that do not repeat when the same word is read.

In the absence of erasure information, error correction and detection circuit 12 will sooner not be able to correct errors. If an uncorrectable error occurs in this way when a word from a particular group is addresses, the circuit may be arranged to respond by reading other words from the same particular group, until a word is found in the particular group that can be successfully corrected. Bit position information about the location of errors in this word may then be stored in erasure memory circuit 16 for use in correcting the original word. This has the advantage that more words may be corrected if some of the errors are random errors that occur only in some of the words in a group. This type of correction may be implemented for example by suitably arranging processing circuitry for this purpose, or by adding additional circuitry to address words from the same group when error correction and detection circuit 12 detects an uncorrectable error This relatively simple algorithm makes it possible to read data correctly from memory locations which otherwise could never have been read errorfree. In principle also the processing element 19 could be used to implement this algorithm, when erasure information from 16 (or 12) is also passed to this processing element 19.

In a further embodiment erasure memory circuit 16 may be implemented to use part of memory matrix 10 for storage of erasure information.

Typically, information about the structure of the groups of words that contains correlated errors is used intrinsically by the circuit, for example through the use of predetermined parts of addresses from processing circuitry 19 to determine which group is addressed. However, in another embodiment this structure information may be supplied explicitly. In this case erasure memory circuit 16 may be arranged to adapt the way the group is determined from the address dependent on the structure information. For example, erasure memory circuit may adapt the number of bits from the address that is used to identify the groups, from the “N” most significant bits to N′ most significant bits for example, and/or it may change the selection of bits from the address that are used to identify the groups (using an address bit from position M′ instead of a bit from a position N for example). Thus, the same erasure circuit may be used with different memories.

It is preferred to use specific hardware circuits for retrieving the erasure information and correcting errors, so that maximum memory speed with minimum memory latency is ensured. However, it will be understood that without deviating from the invention part or all of these functions may be performed by suitably programmed computer circuits. Furthermore, although an electronic circuit implementation has been shown, it should be appreciated that the invention can be applied with other techniques, such as optical devices etc.

1. A data handling device, the device comprising:
a data memory (10) with an address input and a data output, for outputting multi-bit words addressed by addresses from the address input, the data memory (10) having a structure that gives rise to potential errors at correlated positions in words from a group of words with addresses within a group of addresses;
an erasure memory unit (16) coupled to the address input and arranged to store bit position information associated with the group of the words, and to output the bit position information when a word from the group for which bit position information is stored is addressed in the data memory (10);
an error correction and detection unit (12) coupled to the data output of the data memory (10) and to the erasure memory unit (16), and arranged to correct words from the data memory (10), using error erasure for bits at bit positions selected by the bit position information from the erasure memory unit (16), for the groups to which the words belong.

2. A data handling device according to claim 1, wherein the erasure memory unit (16) comprises an associative memory (30, 32, 34), comprising one or more storage locations for storing bit information for no more than a subset of all groups of words in the data memory (10), the one or more storage locations being associatively addressable with the address from the address input of the data memory (10).

3. A data handling device according to claim 2, comprising a cache management unit(18) arranged to select a storage location from the associative memory (30, 32, 34) for reuse for bit position information for a particular group, on detecting an address of a word from that particular group on the address input when no storage location is in use for that particular group.

4. A data handling device according to claim 2, wherein erasure memory unit (16) is arranged to replace bit position information in one of storage locations by bit information for a particular group on detecting an address of a word from that particular group on the address input conditionally if an error is detected in the word form the particular group that is read from the data memory, when no storage location is in use for that particular group

5. A data handling device according to claim 2, wherein the associative memory comprises a storage element (32) for bit information for a single group only.

6. A data handling device according to claim 1, wherein the erasure memory unit (16) is arranged to store validation information associated to the group of the words and to enable use of the bit position information by the error correction and detection circuit only if validated by the validation information, the erasure memory unit (16) being arranged to set the validation information for a particular group to an enabling value only if errors have been detected during at least a plurality of read operations of a word or words from the particular group.

7. A data handling device according to claim 1, comprising a retry circuit coupled to the error correction and detection circuit (12) and the address input of the data memory (10) and arranged to respond to detection of an uncorrectable error for a word from a particular group, by applying the address of at least one other word from the particular group to the data memory, the erasure memory unit (16) being arranged to store bit information for the particular group that is derived from at least one other word.

8. A data handling device according to claim 1, wherein the erasure memory unit (16) is arranged to retrieve the bit information using only a part from an address that is applied to the data input of the data memory, wherein said part identifies the group to which the word belongs, the erasure memory unit being reconfigurable to adapt said part to a type of data memory used.

9. A data handling device according to claim 1, wherein the data memory (10) is a NAND flash memory, the groups containing to words that have bit positions for which data is stored in transistors whose main current channels are connected in series.

10. A method of reading multi-bit data words from a data memory (10), the method comprising:
keeping bit position information associated with at least one group of the words in storage (16), in association with an identification of the group;
outputting the bit position information when a word from the group for which bit position information is stored is addressed in the data memory (10);
correcting words from the data memory under erasure of bits at bit positions selected by the bit position information from the erasure memory unit (16).
